(19) United States
(12) Patent Application Publication
(10) Pub. No.: US 2006/0081190 A1
(43) Pub. Date: Apr. 20, 2006

(54) Solar energy freeze free livestock watering system

(76) Inventor: Mark Ira Ames, Ivins, UT (US)

Correspondence Address: MARK IRA AMES, 60 East 200 North, IVINS, UT, 84738, US

(21) Appl. No.: 11/251,523

(22) Filed: Oct. 13, 2005

Related U.S. Application Data
(60) Provisional application No. 60/619,579, filed on Oct. 18, 2004.

(51) Int. Cl. A01K 7/00

(52) U.S. Cl. 119/73

(57) ABSTRACT

An Improved solar heated freeze free livestock watering system is provided. Which is adapted to allow sunlight to pass through a housing window and impinged onto a water reservoir tank which also is utilized as a passive solar collector on the same area, heating and conducting heat into a water trough and keeping water from freezing. The passive solar heated livestock water system comprises a watering trough with an insulated housing that covers the water trough. The housing has a window on one side to allow sunlight to pass through and impinged onto a passive solar collector, the solar energy heat is conducted into the water trough and into the water keeping it from freezing during cold winter temperatures. The passive solar heated livestock water trough has two ways to fill with water, a simple garden hose or any water line can fill it from the top making it a portable unit, or it can be hooked up to a direct pressurized water line with a float valve shut off to keep ample supply of livestock drinking water. The oval water trough is supported by the insulated housing base frame at the bottom and the oval water trough, and is fastened to the top of the housing with a flange. An oval insulated drinking float that matches the perimeter of the inside of the water trough that floats on top of the water and moves up and down with the water level, livestock push the insulated drinking float down below the water level for access to drink water.

### BRIEF SUMMARY OF THE INVENTION

The present Invention provides a passive solar energy heated livestock water system which is capable of preventing water in a trough from freezing during cold winter conditions, which is capable of keeping water cool with insulation properties during hot summer temperature conditions, supplying ample supply of drinking water to livestock all year long. Broadly, the improved solar energy heated livestock watering system comprises a housing, a drink water trough supported by the housing, a window mounted on the side of the housing, a passive solar collector that features pitted holes to capture sunlight which is on the side of the water trough next to the window. A water flow control float valve is position in the bottom section of the water trough and is connected to a pressurized water line, such as a substantially constant level of water is maintained in the water trough or can be manually filled with water into the water trough with a hose or buckets of water from the top of the water trough. A insulated drinking oval float that is position inside the water trough and floats on top of the drinking water in enabling livestock with their mouth to push down on the oval insulated drinking float submerging it into the water allowing access for livestock to drink an returning to it's former position to insulate water after the livestock is done drinking. The oval insulated drinking water float is positioned by floating on top of the water in the water trough and insulating the water below, keeping the solar energy heated livestock water trough from freezing. Advantages of this solar energy freeze free livestock water trough, there is no electricity or fuels needed only free energy from the sun, it produces no pollutants, it can be used in remote locations, it is portable, it can be moved easily, it requires almost no maintenance.

### BACKGROUND OF INVENTION

1. Field of the Invention

The present Invention relates to a Solar Heated Livestock Water Trough designed to heat water with passive solar energy heat to prevent freezing of the water during cold temperature conditions by Insulation properties.

2. Description of Prior Art

Maintaining a fresh supply of water four seasons a year can be a serious problem for livestock owners. In the winter when freezing temperature conditions are present, a supply of water must be available for livestock. When high temperature conditions are present in the summer coo, supply of water is best for livestock health.

Numerous systems have heretofore and proposed for providing a supply of drinking water to livestock especially in cold winter weather with freezing conditions, typical of such prior art systems are the solar heated stock tank disclosed.

Some systems have heretofore been proposed for providing a supply of water to livestock especially in cold winter weather involving cold freezing temperatures and possibly some prior art systems have incorporated various means to control a level of the water in a passive solar water tank, such prior art systems have been possessed certain inherit problems in that such systems are expensive and heretofore known utilized complex mechanical structures requiring substantial maintenance with no protective housing to protect inner structures that livestock can damage.

### BRIEF DESCRIPTION OF THE DRAWING

FIG. 1. Is a Top view of the Solar Energy Freeze Free Livestock Watering System to show the entrance for livestock to have access to the water by Pushing down on an Insulated Oval flat float.

FIG. 2. Is the Front view of the Solar Energy Freeze Free livestock watering system to show the clear window for solar energy entrance onto the passive Solar collector to heat it.

FIG. 3,4. Show all sectioned parts from the side 1. housing 2. water trough 3. passive solar collector, 4. Window 5, Insulated flat float 6. Insulation.

### DETAILED DESCRIPTION

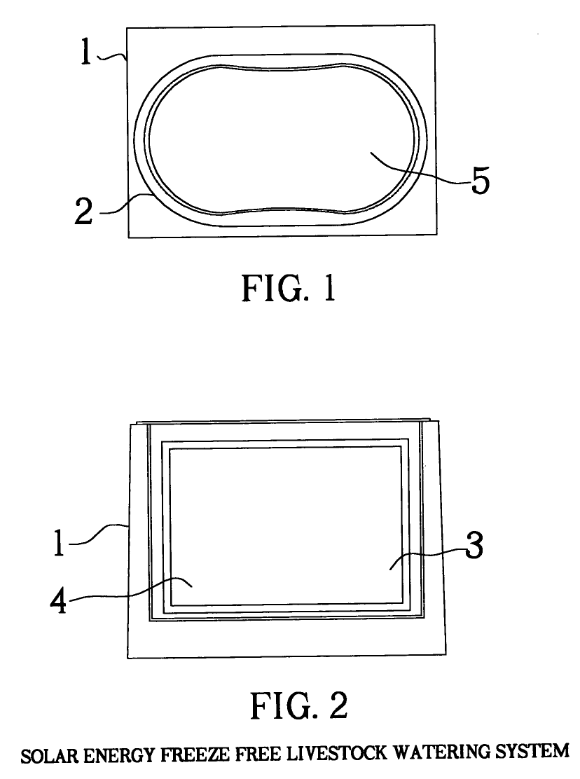

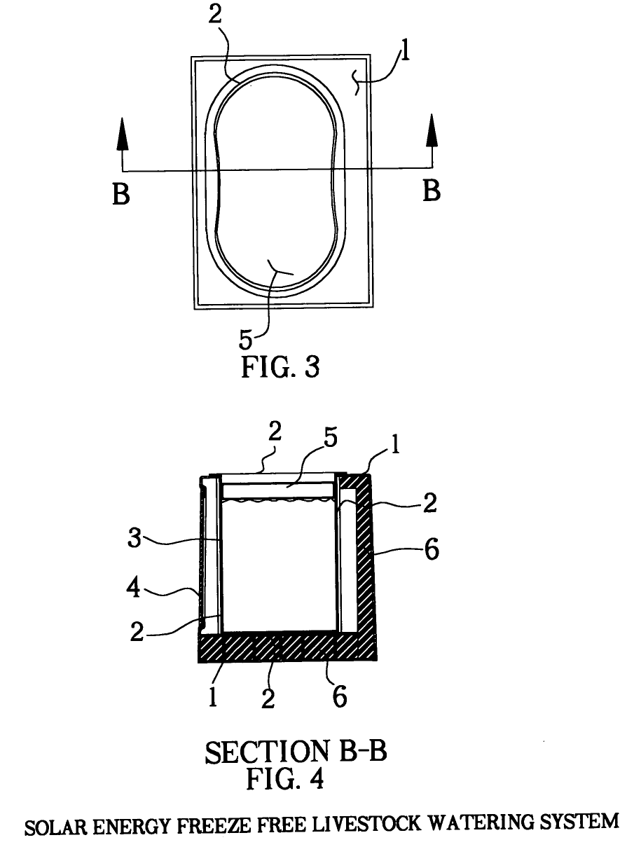

Referring to the drawings, and more particularly to FIG. 1 through 4 a improved solar energy freeze free livestock watering system of the present invention is illustrated. The solar energy freeze free livestock watering system comprises a housing 1, which supports a oval water trough 2, with a flat black absorptive pitted passive solar collector 3, The flat back absorptive pitted passive solar collector 3 is connected to the water trough 2 and is on the outer side of the water trough 2 and is next to the window 4. The sunlight passes through the window 4 and is impinged onto and absorbed into the colored flat black absorptive pitted passive solar collector 3. The colored flat black absorptive pitted passive solar collector 3 is pitted to capture majority of the sun light energy impinged onto it by trapping and stopping reflection in the pitted holes and on the face of the flat black pitted passive solar collector 3, which then the sunlight is transformed into heat transferring from the flat black absorptive pitted passive solar collector 3. Through the wall of the oval water trough 2 and in to the water of the oval water trough 2. Heating the water and keeping it from freezing during cold winter conditions allowing livestock to drink and consume water.

The oval water trough 2 is accessible for livestock to drink and consume water through the top of thee housing 1 and the opening of the oval water trough 2 on the topside. The oval float 5 is positioned in the oval water trough 2 and floats on top of the water and insulates the water in the oval water trough 2, livestock push down on this float 5 with their mouth to gain access to the water to drink and consume the water in the oval water trough 2. The oval float 5 floats on top of the water and moves up and down in the oval water trough 2 with the water level, as livestock drink and consume water the float 5 moves down in the oval water trough with the water level, when water replenished the float 5 moves up in the oval water trough with the water level. The oval water trough 2 is insulated on 4 sides with insulation 6, with dead air space between the window 4 and the flat black pitted passive solar collector 3 to allow sunlight to power the solar energy freeze free livestock water system.

### Specification

A solar energy freeze free livestock watering system that keeps water in its system from freezing during cold winter conditions, by using passive solar energy as a heat source to power it. The solar energy freeze free livestock watering system is made of a housing, with a window on one side to let sunlight in, to impinge upon the passive solar collector turning it to heat and transform the heat into the water trough, by conducting the heat from the passive solar collector, which is on the side of the water trough through the wall into the water, thus keeping it freeze free in winter. In summer times hot temperatures, the livestock watering system uses a summer time cover over the window and blocks sun light from the passive solar collector thus keeping the water cool in the system because of the insulated housing qualities.

I claim:

1. an improved solar energy freeze free livestock watering system comprising an oval flat black float that moves up and down with the water level in the water trough, the oval flat black float covers the top of the water and is parallel to the side walls of the water trough insulating and trapping the heat in the water in the water trough, to prevent freezing of water for livestock to drink water by pushing down with there mouth on the oval flat black float to have access to consume water during cold winter temperatures, the system can be filled manually or with a auto water fill valve. The oval flat black float allows two livestock to drink at the same time lowering costs and promoting good drinking habits for livestock, as livestock tend to drink together at the same time in herds, from draft horses to small livestock.

2. Flat Black absorptive Pitted passive solar collector that stops sunlight reflections and traps all types of sunlight in the pitted holes in the passive solar collector, by powering and maximizing the suns light and transferring it into heat, thus transferring it into the water trough to heat the water to prevent it from freezing for livestock consumption during cold winter temperatures.

3. A water trough with a smooth surface that prevents ice from sticking to the water trough and the oval flat black float, aided by corn oil to keep the oval flat back float free from sticking to ice and the water trough, operable for livestock to push down on the oval flat black float into the water for access for livestock to drink from the water trough, during cold winter temperatures.

4. An insulated water trough with a housing with a summertime cover that blocks the window on the housing and covers the flat black pitted passive solar collector, that keeps water cool in summer times hot temperatures, making livestock water consumption plentiful with better livestock husbandry, production and health.

5. An Enclosed water trough that prevents algae from growing in the water allowing less cleaning, maintenance and better livestock health.

6. An absorptive type insulation that insulates the water trough and absorbs any moisture inside the housing, preventing any moisture accumulation on the inside of the window and preventing sunlight blockage that could stop sunlight going through the window and passive solar powering the flat black pitted passive solar collector during cold winter temperatures.
